(19) United States
(12) Patent Application Publication
(10) Pub. No.: US 2017/0337469 A1
(43) Pub. Date: Nov. 23, 2017

(54) ANOMALY DETECTION USING SPIKING NEURAL NETWORKS

(71) Applicant: AGT INTERNATIONAL GMBH, Zurich (CH)

(72) Inventors: Christian DEBES, Darmstadt (DE); Bjorn DEISEROTH, Darmstadt (DE)

(21) Appl. No.: 15/156,526

(22) Filed: May 17, 2016

(51) Int. Cl. G06N 3/08; G06K 9/00; G06N 3/04

(52) U.S. Cl. CPC G06N 3/08; G06N 3/04; G06K 9/00718; G06K 2009/00738

(57) ABSTRACT

A method, system and computer program product, for identifying anomalies in a monitored scene, the method comprising: receiving into a spiking neural network sensor readings from a capture device monitoring a scene; and outputting an indication to a change in the scene, wherein the spiking neural network comprises a multiplicity of layers, each of the multiplicity of layers comprising a neuron per substantially each pixel in a sensor capturing the monitored scene, and wherein one or more of the layers comprises a memory-like unit for comparing states occurring at a time difference.

### TECHNICAL FIELD

The presently disclosed subject matter relates to anomaly detection, and more particularly to detecting anomalies in a monitored scene.

### BACKGROUND

Problems of monitoring scenes have been recognized in the conventional art and various techniques have been developed to provide solutions, for example:

“Dynamic evolving spiking neural networks for on-line spatio- and spectro-temporal pattern recognition”, Neural Networks 41 (2013), 188-201 relates to on-line learning and recognition of spatio- and spectro-temporal data (SSTD) which is important for the future development of autonomous machine learning systems with broad applications. Models based on SNN have already proved their potential in capturing spatial and temporal data. One class, the evolving SNN (eSNN), uses a one-pass rank-order learning mechanism and a strategy to evolve a new spiking neuron and new connections to learn new patterns from incoming data. So far these networks have been mainly used for fast image and speech frame-based recognition. Alternative spike-time learning methods, such as Spike-Timing Dependent Plasticity (STDP) and its variant Spike Driven Synaptic Plasticity (SDSP), can also be used to learn spatio-temporal representations, but they usually require many iterations in an unsupervised or semi-supervised mode of learning. A new class of eSNN is presented, dynamic eSNN (deSNN), that utilizes both rank-order learning and dynamic synapses to learn SSTD in a fast, on-line mode. These deSNN utilize SDSP spike-time learning in unsupervised, supervised, or semi-supervised modes. The SDSP learning is used to evolve dynamically the network changing connection weights that capture spatio-temporal spike data clusters both during training and during recall. The new deSNN model is illustrated on simple examples and then applied on two case study applications: (1) moving object recognition using address-event representation (AER) with data collected using a silicon retina device; (2) EEG SSTD recognition for brain-computer interfaces.

“Mapping from Frame-Driven to Frame-Free Event-Driven Vision Systems by Low-Rate Rate Coding and Coincidence Processing—Application to Feedforward ConvNets”, Perez-Carrasco et al, Pattern Analysis and Machine Intelligence, IEEE Transactions 2013 relates to event-driven visual sensors which provide visual information in quite a different way from conventional video systems consisting of sequences of still images rendered at a given “frame rate.” Event-driven vision sensors take inspiration from biology. Each pixel sends out an event (spike) when it senses something meaningful is happening, without any notion of a frame. A special type of event-driven sensor is the so-called dynamic vision sensor (DVS) where each pixel computes relative changes of light or “temporal contrast.” The sensor output consists of a continuous flow of pixel events that represent the moving objects in the scene. Pixel events become available with microsecond delays with respect to “reality.” These events can be processed “as they flow” by a cascade of event (convolution) processors. As a result, input and output event flows are practically coincident in time, and objects can be recognized as soon as the sensor provides enough meaningful events. The paper presents a methodology for mapping from a properly trained neural network in a conventional frame-driven representation to an event-driven representation. The method is illustrated by studying event-driven convolutional neural networks (ConvNet) trained to recognize rotating human silhouettes or high speed poker card symbols. The event-driven ConvNet is fed with recordings obtained from a real DVS camera. The event-driven ConvNet is simulated with a dedicated event-driven simulator and consists of a number of event-driven processing modules, the characteristics of which are obtained from individually manufactured hardware modules.

“Character Recognition using Spiking Neural Networks”, Ankur Gupta and Lyle N. Long, IEEE Neural Networks Conference 2007 discloses a spiking neural network model used to identify characters in a character set. The network is a two layered structure consisting of integrate-and-fire and active dendrite neurons. There are both excitatory and inhibitory connections in the network. Spike time dependent plasticity (STDP) is used for training. It is found that most of the characters are recognized in a character set consisting of 48 characters.

“HFirst: A Temporal Approach to Object Recognition”, IEEE Transactions on Pattern analysis and Machine Intelligence, vol 37, issue 10, pg. 2028-2040, 2015 introduces a spiking hierarchical model for object recognition which utilizes the precise timing information inherently present in the output of biologically inspired asynchronous address event representation (AER) vision sensors. The asynchronous nature of these systems frees computation and communication from the rigid predetermined timing enforced by system clocks in conventional systems. Freedom from rigid timing constraints opens the possibility of using true timing to our advantage in computation. It is shown not only how timing can be used in object recognition, but also how it can in fact simplify computation. Specifically, a simple temporal-winner-take-all operation is relied on rather than more computationally intensive synchronous operations typically used in biologically inspired neural networks for object recognition.

“Unsupervised Learning of Digit Recognition Using Spike-Timing-Dependent Plasticity”, Banafsheh Rekabdar, Monica Nicolescu, Richard Kelley, Mircea Nicolescu, Artificial General Intelligence, Lecture Notes in Computer Science 2014 is aimed at understanding how the mammalian neocortex is performing computations, and claims that two things are necessary: understanding of the available neuronal processing units and mechanisms, and of how those mechanisms are combined to build functioning systems. Therefore, there is an increasing interest in how spiking neural networks (SNN) can be used to perform complex computations or solve pattern recognition tasks. However, it remains a challenging task to design SNNs which use biologically plausible mechanisms (especially for learning new patterns), since most such SNN architectures rely on training in a rate-based network and subsequent conversion to a SNN. An SNN is presented for digit recognition which is based on mechanisms with increased biological plausibility, i.e., conductance-based instead of current-based synapses, spike-timing-dependent plasticity with time-dependent weight change, lateral inhibition, and an adaptive spiking threshold. Unlike most other systems, a teaching signal is not used and class labels are not presented to the network. The fact that no domain-specific knowledge is used points toward the general applicability of the network design and the performance of the network scales well with the number of neurons used and shows similar performance for four different learning rules, indicating robustness of the full combination of mechanisms, which suggests applicability in heterogeneous biological neural networks.

US20120308136 by Izhikevich discloses an object recognition apparatus and methods useful for extracting information from sensory input. In one embodiment, the input signal is representative of an element of an image, and the extracted information is encoded in a pulsed output signal. The information is encoded in one variant as a pattern of pulse latencies relative to an occurrence of a temporal event; e.g., the appearance of a new visual frame or movement of the image. The pattern of pulses advantageously is substantially insensitive to such image parameters as size, position, and orientation, so the image identity can be readily decoded. The size, position, and rotation affect the timing of occurrence of the pattern relative to the event; hence, changing the image size or position will not change the pattern of relative pulse latencies but will shift it in time, e.g., will advance or delay its occurrence.

US20130297539 by Piekniewski et al. discloses an apparatus and methods for feedback in a spiking neural network. In one approach, spiking neurons receive sensory stimulus and context signal that correspond to the same context. When the stimulus provides sufficient excitation, neurons generate response. Context connections are adjusted according to inverse spike-timing dependent plasticity. When the context signal precedes the post synaptic spike, context synaptic connections are depressed. Conversely, whenever the context signal follows the post synaptic spike, the connections are potentiated. The inverse STDP connection adjustment ensures precise control of feedback-induced firing, eliminates runaway positive feedback loops, enables self-stabilizing network operation. In another aspect of the invention, the connection adjustment methodology facilitates robust context switching when processing visual information. When a context (such an object) becomes intermittently absent, prior context connection potentiation enables firing for a period of time. If the object remains absent, the connection becomes depressed thereby preventing further firing.

U.S. Pat. No. 8,346,692 to Rouat et al. discloses a spiking neural network having a layer of connected neurons exchanging signals. Each neuron is connected to at least one other neuron. A neuron is active if it spikes at least once during a time interval. Time-varying synaptic weights are computed between each neuron and at least one other neuron connected thereto. These weights are computed according to a number of active neurons that are connected to the neuron. The weights are also computed according to an activity of the spiking neural network during the time interval. Spiking of each neuron is synchronized according to a number of active neurons connected to the neuron and according to the weights. A pattern is submitted to the spiking neural network for generating sequences of spikes, which are modulated over time by the spiking synchronization. The pattern is characterized according to the sequences of spikes generated in the spiking neural network.

“Simplified spiking neural network architecture and STDP learning algorithm applied to image classification”, Eurasip Journal on Image and Video Processing 2015 relates to using SNNs in embedded applications such as robotics and computer vision. The main advantages of SNN are the temporal plasticity, ease of use in neural interface circuits and reduced computation complexity. SNN have been successfully used for image classification and provide a model for the mammalian visual cortex, image segmentation and pattern recognition. Different spiking neuron mathematical models exist, but their computational complexity makes them ill-suited for hardware implementation. In this paper, a model of spike response model (SRM) neuron with spike-time dependent plasticity (STDP) learning is presented. Frequency spike coding based on receptive fields is used for data representation; images are encoded by the network and processed in a similar manner as the primary layers in visual cortex. The network output can be used as a primary feature extractor for further refined recognition or as a simple object classifier. The proposed solution combines spike encoding, network topology, neuron membrane model and STDP learning.

The references cited above teach background information that may be applicable to the presently disclosed subject matter. Therefore the full contents of these publications are incorporated by reference herein where appropriate for appropriate teachings of additional or alternative details, features and/or technical background.

### GENERAL DESCRIPTION

The disclosed subject matter provides for identifying anomalies in a monitored scene using a spiking neural network having a memory-like unit. The disclosed subject matter allows for efficient processing of video streams, in an unsupervised manner.

In accordance with one embodiment of the disclosed subject matter, there is thus provided a computer-implemented method for identifying anomalies in a monitored scene, comprising: receiving into a spiking neural network sensor readings from a capture device monitoring a scene; and outputting an indication to a change in the scene, wherein the spiking neural network comprises a multiplicity of layers, each of the multiplicity of layers comprising a neuron per substantially each pixel in a sensor capturing the monitored scene, and wherein one or more of the layers comprises a memory-like unit for comparing states occurring at a time difference. Within the method, the memory-like unit optionally uses a spike-timing-dependent plasticity (STDP) process. Within the method, the neural network is optionally implemented in hardware. Within the method, the spiking neural network optionally comprises: a time to first spike layer comprising a grid of first neurons, each of the first neurons receiving a sensor reading and converting the sensor reading into time by firing a first spike; a waver layer comprising a grid of second neurons, each of the second neurons connected to receive as input the first spike issued by a corresponding first neuron, the waver layer configured to perform first noise filtering within the input and fire a second set of spikes; a layer of interest comprising a grid of third neurons, each of the third neurons connected to receive as input spikes from the second set of spikes issued by a corresponding second neuron, the layer of interest configured to perform a second noise filtering stage by part of the third neurons firing a third set of spikes substantially simultaneously; and a change layer comprising a grid of fourth neurons, each of the fourth neurons connected to receive as input a spike from the third set of spikes issued by a corresponding third neuron, and detecting a change between a stored state and a current state using the memory-like unit. Within the method, the second neurons of the waver layer are optionally interconnected, and wherein the first noise filtering is optionally performed by one or more of the second neurons firing a spike to another neuron from the second neurons, thereby one or more of the second neurons firing multiple spikes per iteration. The method may optionally further comprise a hillclimb neuron receiving input from a multiplicity of the second neurons and providing output to the third neurons, the hillclimb neuron spiking when a number of input spikes decreases, and making the part of the third neurons fire the third set of spikes substantially simultaneously. Within the method, an anomaly is optionally detected as change detected in at least a predetermined number of the fourth neurons. The method is optionally unsupervised.

In accordance with another embodiment of the disclosed subject matter, there is thus provided a computerized system for projecting a machine learning model, the system comprising a processor, the system configured to: receiving sensor readings from a capture device monitoring a scene into a spiking neural network; and outputting by the processor an indication to a change in the scene, wherein the spiking neural network comprises a multiplicity of layers, each of the multiplicity of layers comprising a neuron per substantially each pixel in a sensor capturing the monitored scene, and wherein one or more of the layers comprises a memory-like unit for comparing states occurring at a time difference. Within the system, the memory-like unit optionally uses a spike-timing-dependent plasticity (STDP) process. Within the system, the neural network is optionally implemented in hardware. Within the system, the spiking neural network optionally comprises: a time to first spike layer comprising a grid of first neurons, each of the first neurons receiving a sensor reading and converting the sensor reading into time by firing a first spike; a waver layer comprising a grid of second neurons, each of the second neurons connected to receive as input the first spike issued by a corresponding first neuron, the waver layer configured to perform first noise filtering within the input and fire a second set of spikes; a layer of interest comprising a grid of third neurons, each of the third neurons connected to receive as input spikes from the second set of spikes issued by a corresponding second neuron, the layer of interest configured to perform a second noise filtering stage by at least part of the third neurons firing a third set of spikes substantially simultaneously; and a change layer comprising a grid of fourth neurons, each of the fourth neurons connected to receive as input a spike from the third set of spikes issued by a corresponding third neuron, and detecting a change between a stored state and a current state using the memory-like unit. Within the system, the second neurons of the waver layer are optionally interconnected, and the first noise filtering is optionally performed by one or more of the second neurons firing a spike to another neuron from the second neurons, thereby one or more of the second neurons firing multiple spikes per iteration. The system may optionally further comprise a hillclimb neuron for receiving input from a multiplicity of the second neurons and providing output to the third neurons, the hillclimb neuron spiking when a number of input spikes decreases, and making part of the third neurons fire the third set of spikes substantially simultaneously. Within the system, an anomaly is optionally detected as change detected in at least a predetermined number of the fourth neurons.

In accordance with yet another embodiment of the disclosed subject matter, there is thus provided a computerized computer program product comprising a computer readable storage medium retaining program instructions, which program instructions when read by a processor, cause the processor to perform a method comprising: receiving into a spiking neural network sensor readings from a capture device monitoring a scene; and outputting an indication to a change in the scene, wherein the spiking neural network comprises a multiplicity of layers, each of the multiplicity of layers comprising a neuron per substantially each pixel in a sensor capturing the monitored scene, and wherein one or more of the layers comprises a memory-like unit for comparing states occurring at a time difference.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates input signals going over a neuron and the resulting neuron state in a neural network;

FIG. 2 illustrates a generalized block diagram of a system for detecting changes in a monitored scene using a spiking neural network, in accordance with certain embodiments of the presently disclosed subject matter;

FIG. 3A illustrates a schematic diagram of a spiking neural network for detecting changes in a monitored scene, in accordance with certain embodiments of the presently disclosed subject matter;

FIG. 3B shows an exemplary input frame and the resulting frame after being processed by method associated with the spiking neural, in accordance with certain embodiments of the presently disclosed subject matter;

FIG. 4A shows a schematic diagram of a hillclimb mechanism implemented within a spiking neural network, in accordance with certain embodiments of the presently disclosed subject matter;

FIG. 4B illustrates schematic graphs of inhibiting and exciting input and the output of a hill neuron, in accordance with certain embodiments of the presently disclosed subject matter;

FIG. 4C illustrates a schematic diagram of a memory-like unit implemented using elements of spiking neural network, in accordance with certain embodiments of the presently disclosed subject matter;

FIG. 4D shows exemplary experimental graphs of weights and spiking times of a pre-post mechanism, in accordance with certain embodiments of the presently disclosed subject matter; and

FIG. 5 illustrates a generalized flow-chart of a method for detecting changes in a monitored scene using a spiking neural network, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Embodiments of the presently disclosed subject matter are not described with reference to any particular programming language. It will be appreciated that a variety of programming languages may be used to implement the teachings of the presently disclosed subject matter as described herein.

Unless specifically stated otherwise, as apparent from the following discussions, it is appreciated that throughout the specification discussions utilizing terms such as “processing”, “computing”, “representing”, “comparing”, “generating”, “assessing”, “matching”, “updating”, “determining”, “calculating”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, disclosed in the present application.

The terms “non-transitory memory” and “non-transitory storage medium” used herein should be expansively construed to include any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

The operations in accordance with the teachings herein may be performed by a chip simulating spiking neurons and corresponding synapses, and configured in accordance with appropriate configuration instructions to simulate a spiking neural network in accordance with the disclosure.

The term “neural network” (NN) or “artificial neural network” (ANN) used in this disclosure should be expansively construed to cover any structure or model utilizing guidelines following or trying to imitate biological neural networks, and can be used to estimate or approximate generally unknown functions that can depend on a large number of inputs. Artificial neural networks are generally presented as systems of interconnected nodes termed “neurons” which exchange (also referred to as “firing” or “transmitting”) messages (also referred to as “events” or “spikes”) between each other over the connections, termed “synapses”. Synapses may have a numeric weight that can be tuned, thus making NNs adaptive to inputs and capable of learning.

The term “spiking neural network” (SNN) used in this disclosure should be expansively construed to cover any kind of neural network that in addition to neuronal and synaptic state, also incorporates the concept of time. Neurons in an SNN do not fire at each propagation cycle but only when an intrinsic property of the neuron, for example a property related to its membrane electrical charge, reaches a specific value. When a first neuron fires, it generates a spike which leaves a fast decaying trace on a synapse connecting the first neuron to one or more second neurons. The spike received at the second neuron is integrated into the second neuron, i.e. increases or decreases the capacity state of the second neuron in accordance with this signal. The current activation level of a neuron may be considered to be the neuron's state, with incoming spikes pushing this value higher or lower, depending on whether the synapse over which they are incoming is exciting or inhibiting. Then either the neuron fires and resets its capacity, or its state decays over time to the rest capacity. Thus, compared to traditional neural networks, in spiking neural network timing becomes an important role, as states tend to decay back to default values, and information becomes encoded in spiking times, or relative spike distances, rather than being retrievable values at arbitrary time.

Synapses between a first neuron and a second neuron may be static or dynamic. The weight of static synapses is constant, while the weight of dynamic synapses may change. The weights may be adjusted by a spike-timing-dependent plasticity (STDP) process. The process is such that inputs that might be the cause of the post-synaptic second neuron's excitation are assigned higher weight and are made even more likely to contribute in the future, whereas inputs that are not the cause of the post-synaptic spike are assigned lower weight and are made less likely to contribute in the future. The likelihood is estimated by the time difference between the times at which a spike is provided by the synapse and the time at which the second neuron spikes. The shorter the time difference, the more likely it is that the synapse is the cause for the second neuron firing.

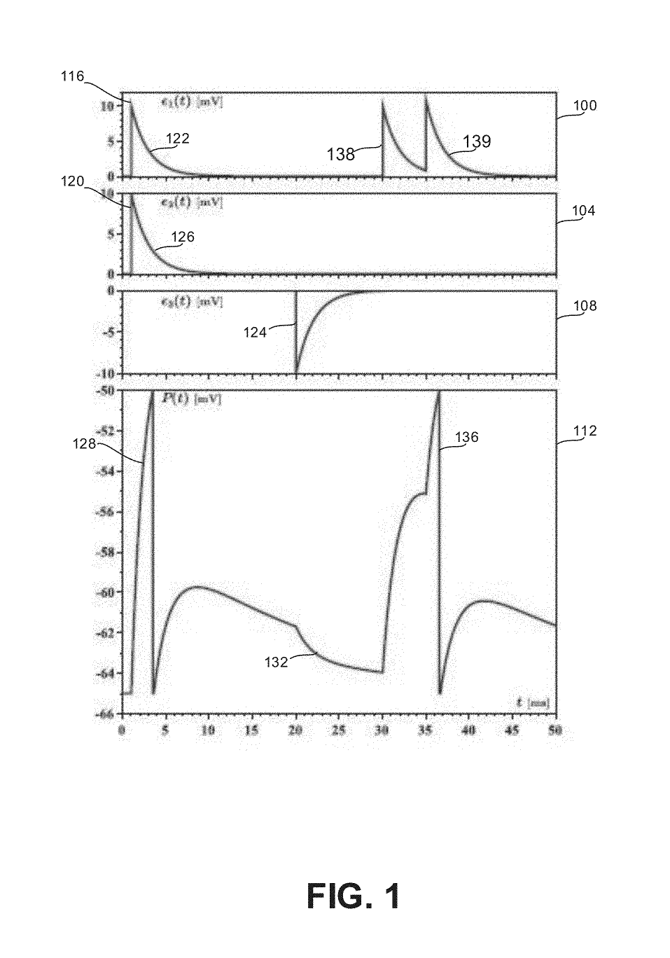

Referring now to FIG. 1, showing exemplary graphs 100, 104 and 108 of signals advancing through three synapses going into one neuron, wherein signals 100 and 104 go over exciting synapses while signal 108 goes over an inhibiting synapse. FIG. 1 further shows a graph 112 of the potential of the neuron. It is seen that simultaneous spikes 116 and 120, coming over two different exciting synapses cause the neuron to reach the firing potential after which its potential goes down and is slowly increased by the positive (although decaying) parts 122 and 126 of the first two synapses. The potential goes in a sharper manner down with spike 124 over the inhibiting synapse, and then goes up with exciting spikes 138 and 139 both incoming over the first exciting synapse. The potential goes sharply down after the neuron fires spike 136.

The disclosure relates to identifying abnormal behaviors in scenes monitored by video cameras. It will be appreciated that the usage of a large number of cameras or high resolutions may obtain significant quantity of information and better monitoring, but at high price in computational, transmittal, bandwidth, storage, or other resources.

One type of solutions relates to “processing at the edge” where the nodes, e.g., the cameras or computing platforms that directly receive information from the cameras are equipped with more computational power and can thus transmit to a remote location such as a control center only relevant and condensed information, thus saving transmittal bandwidth, computations by a central unit, storage, or the like.

The combination of “processing at the edge” and spiking NN thus provides improved computation speed, as well as energy consumption as compared to classical constructions.

Neural networks and in particular spiking neural networks may be used for processing the received information, for example at or near the end unit. The spiking neural network, also referred to as a “network”, may be designed for detecting changes in a monitored scene. The network may be implemented as a set of layers. Each layer may comprise an element implementing a neuron per each pixel of the input frame as obtained for example from a video camera, wherein the first layer may connect directly to a CMOS sensor of a video camera. Thus, the network may receive as input each pixel of the input frame into an element implementing a neuron, and output an indication to whether or not the scene has changed, or a processed image in which changes may be more prominent. Due to the high computational performance, the input stream may be processed in real-time, producing an enhanced output stream, and therefore leaving the information paradigm invariant, compared to classical offline processing approaches.

A neural network may be implemented as a fixed structure, comprising elements functioning as neurons having predetermined connections to other neurons.

In other embodiments, a neuromorphic chip may be used, which is a chip comprising a multiplicity of neuron-like elements, with many physical interconnections, wherein only some of the interconnections, in accordance with the required network structure, are configured to be active and used. Thus, the structure of the network may be determined or changed dynamically according to the implemented application.

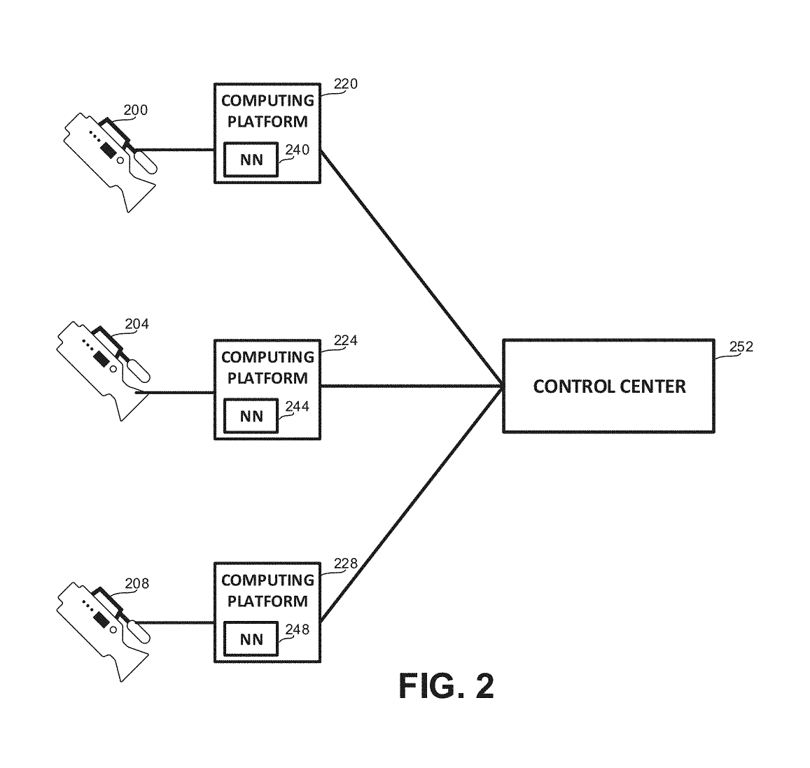

Referring now to FIG. 2, showing a schematic illustration of a monitoring system utilizing such spiking neural networks.

The system may comprise a multiplicity of capturing devices such as video camera 200, 204 and 208, capturing the same area or different areas.

Each video camera is associated with a computing platform such as computing platform 220 associated with video camera 200, computing platform 224 associated with video camera 204, and computing platform 228 associated with video camera 208. In some embodiments, the computing platform may be embedded within the camera, while in other embodiments it may be a separate platform connected to the video camera through any wired or wireless channel and any protocol. The output of each pixel in the CMOS sensor for the camera, or any other component that provides an indication to a segment of the monitored scene, may be connected to a neural network implemented by the respective computing platform, such as NN 240 implemented by or associated with computing platform 220, NN 244 implemented by or associated with computing platform 224 or NN 248 implemented by or associated with computing platform 228. Each neural network may analyze the values received from the respective video camera and outputs an indication whether one or more of the received frames represent a change in the scene relatively to one or more preceding frames. The respective computing platform can transmit the output to a control center 252, which may be a manned control room, a computerized center or the like. Control center 252 may also store the received indications.

In some embodiments, if there is an indication by a NN that a change indeed occurred, the respective computing platform can transmit also the captured video to control center 252, where it may be recorded. Additionally or alternatively, the respective computing platform may also record the captured video, may send a command to the camera to increase resolution, or take any other action.

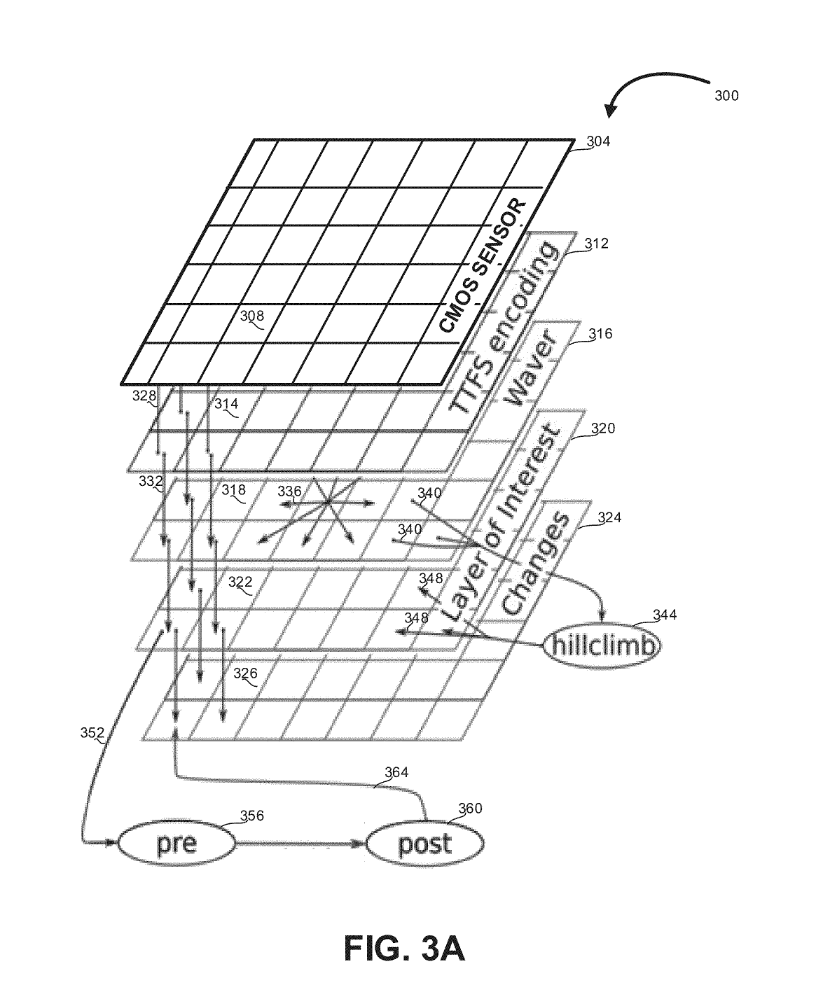

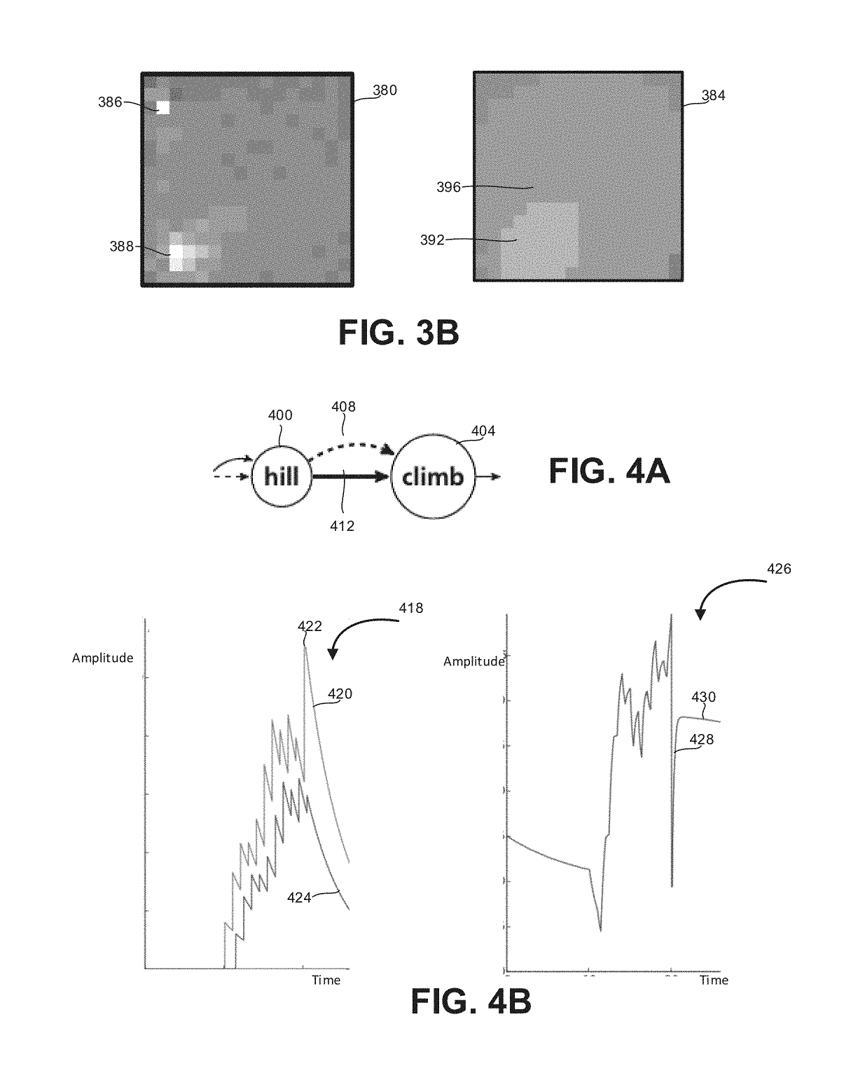

Referring now to FIG. 3A, illustrating a schematic diagram of a spiking neural network for detecting changes in a monitored scene, in accordance with certain embodiments of the presently disclosed subject matter.

The spiking neural network, generally referenced 300 may be made up of the depicted layers, including Time-To-First-Spike (TTFS) layer 312, waver layer 316, layer of interest (LOI) 320 and changes layer 324. Each layer is made up of neural elements arranged such that the layer comprises a neural element corresponding to each pixel 308 of CMOS sensor 304, which outputs a value indicative of the intensity of light at a part of the monitored scene.

Each TTFS element 314 of TTFS layer 312 can receive a grayscale value, for example between 0 and 255, from corresponding pixel 308 of CMOS sensor 304, via a currency injection synapse. TTFS element 314 can convert the grayscale value into a spike time, for example in the range of 0 to 255 mSec.

Thus, in this example, every 255 mSec the spikes advance one layer, and the network may thus process the output of a camera that produces a frame every at least 255 mSec. It will be appreciated that the encoding can be optimized for allowing higher frame rates, for example in microseconds.

Each TTFS element 314 of TTFS layer 312 can then provide the output signal to a corresponding waver element 318 of waver layer 316. Thus, each waver element 318 receives the spikes fired by TTFS element 314.

Waver layer 316 can comprise interconnections 336 between neighboring elements 318. The interconnections can be implemented as synapses having weights indicative of the distance between waver elements 318. Thus, when a waver element 318 fires a spike, the spike is received by corresponding LOI element 322 of LOI 320, as well as by its neighboring waver elements 318. These interconnections produce a wave-like behavior which may be viewed as a first noise filter, by letting pixels with similar values keep spiking together, because each neuron in waver layer 316 excites its neighborhood, thus neighboring neurons keep exciting each other and therefore spiking, optionally until inhibited. At the same time, the spikes present connected component behavior, since only neurons with similar values, i.e. similar spiking times, and which are connected by some path of neurons representing similar values spike together. Further reasoning for the similar spiking times is provided below in association with the description of the hillclimb mechanism.

It will be appreciated that similar spiking times represent similar grayscale values. It will also be appreciated that the level of connectedness or noise resistance between connected neurons can be defined by the weights of the synapses between connected elements, i.e., the waving behavior.

In some embodiments, one or more waver elements 318 may have a self-inhibitory synapse, to enforce a single spike only.

Additionally, the output of all waver elements 318 may also be fed into a single hillclimb element 344. Hillclimb element 344 may sample the peak state of waver layer 316 in which the most neurons in waver layer 316 spike. Sampling may be performed by “counting” the total number of neurons spiking at a predetermined time interval and waiting for a decrease in the number. Hillclimb 344 may spike when the maximum spikes from waver layer 316 decreases, and may provide this spike to each of LOI elements 322 of LOI 320 as follows:

Each spiking neuron in waver layer 316 injects an amount to a corresponding neuron in LOI 320 which is insufficient for spiking, but brings it to the “spike ready state”. This, as well as the decay of neurons in LOI 320 prevents them from spiking, unless additional input is received from hillclimb 344. Hillclimb 344 samples the peak activity of waver layer 316, and injects high amount of energy into every LOI element 322 of LOI 320. However the energy level is such, that only those LOI elements 322 which are in “spike ready” state, due to the input received directly from the corresponding waver element 318, indeed spike. Due to the single hillclimb unit, all LOI elements 322 that are in “spike ready” state, then spike together. However, it will be appreciated that in some embodiments more than one hillclimb 344 may be used, each receiving input from a multiplicity of neurons in waver layer 316 and providing output to a multiplicity of neurons in LOI 320.

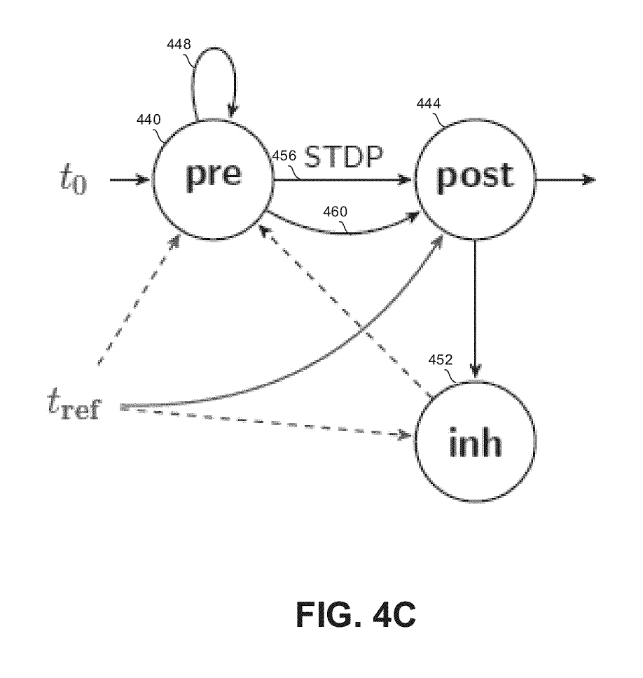

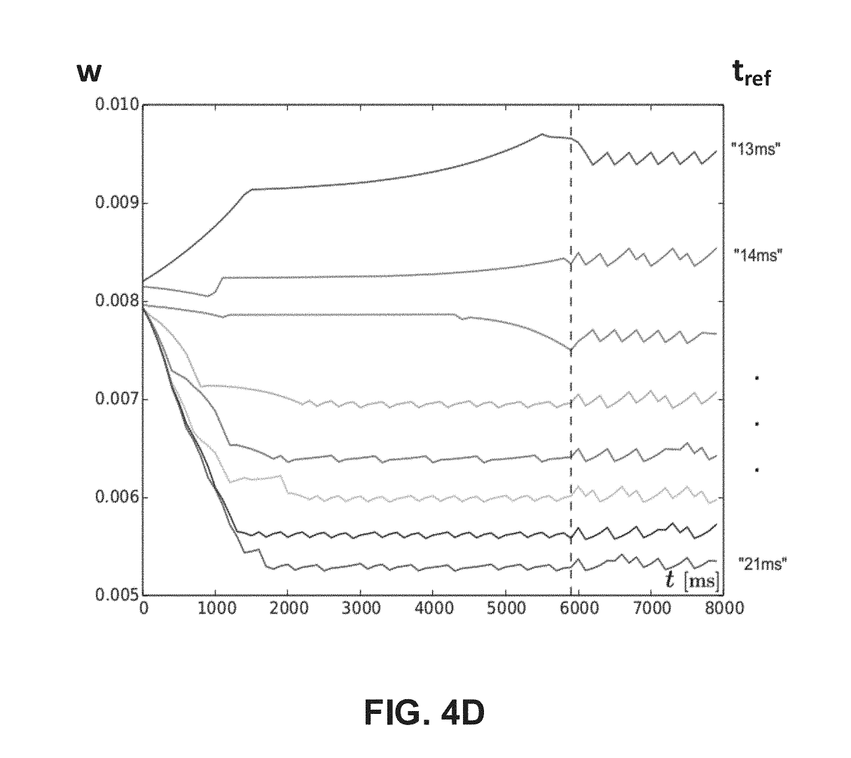

Hillclimb 344 is further detailed in association with FIG. 4A below.

The result of the wave-like behavior of waver layer 316 together with hillclimb 344 is that neighboring LOI element 322 of LOI layer 320, which correspond to neighboring pixels may receive a spike at the same time, i.e. equivalent to having the same gray level, with some average value close to the maximal value of the area. This behavior causes noise within small areas, which may be objects of interest, to be more noticeable, since these areas are rather fast in adjusting to changes. In some embodiments, this input noise may be exploited to realize anomaly (object) tracking rather than anomaly detection. Large areas, on the other hand, which may be the background, behave in a more “lazy” manner, i.e., the average value changes rather slowly and isolated noise is removed by the wave.

Referring now to FIG. 3B, showing an exemplary input grayscale image 380, and image 384 which is the grayscale equivalent of the result of processing image 380 by waver layer and hillclimb 344, and thus the output of the LOI layer 320. Image 384 comprises an isolated noisy region 386 which is eliminated in the resulting image, and a larger “active” area 388 which is processed into a larger area 392 and even further larger area 396 in image 384 due to the wave-like behavior in which neurons excite each other. Areas 392 and 396 are of substantially uniform gray levels due to the hillclimb behavior which unites different firing times (i.e. different gray levels) into one.

Each LOI element 322 of LOI 320 thus receives the output of the corresponding waver element 318, as may have been influenced by its neighbors, and the output of hillclimb 344.

Each LOI element 322 of LOI 320 transmits its value to a corresponding changes element 326 of changes layer 324 in inhibiting mode. Each LOI element 322 of LOI 320 also transmits (352) its value for storage, encoded in a corresponding pre-post unit detailed in association with FIG. 4C below, wherein a previously stored value is made available at a post neuron 360, which transmits its value to the corresponding changes element 326 in exciting mode. Thus each pair of LOI element 322 of LOI 320 and the corresponding change element 326 of change layer 324 are connected to each other directly and also by a pre-post unit, by synapses having opposite modes.

This pre-post unit implementing memory-like mechanism is further detailed in association with FIG. 4C below.

Change element 326 of change layer 324 may receive the current value from the corresponding LOI element 322 of LOI 320 as an inhibiting signal, and the previous value from the respective pre-post mechanism as an exciting signal, or vice versa. If both fire simultaneously then they will cancel each other and change element 326 will not fire. However, if they fire at different times, change element 326 will spike and indicate a change on the respective pixel, at the time corresponding to its current gray level.

The spikes fired by change elements 326 may be globalized over changes layer 324. For example, the network may indicate a change in the scene if a change is detected in at least a predetermined number of changes elements 326, or in at least a certain percentage of changes elements 326. In some embodiments, the value change may also be considered, for example by indicating a scene change upon the sum of all value changes exceeding a predetermined value, or the like.

It will be appreciated that waver layer 316 and LOI 320, together with hillclimb 344 provide for noise cancellation, LOI 320 and changes layer 324 provide for change detection and possibly object tracking.

Referring now to FIG. 4A illustrating a schematic diagram of a hillclimb structure. The hillclimb structure comprises two neurons, “hill” 400 and “climb” 404, connected by exciting synapse 412 and inhibiting synapse 408. Reference is also made to FIG. 4B, demonstrating the dual transmission to “hill” neuron 400.

Input from each waver element 318 in waver layer 316 may be transmitted to the hillclimb structure twice, in inhibiting mode immediately, and in exciting mode with a delay.

Thus, hill neuron 400 receives the same signals twice, but with different weight and delay, therefore, the signals are shifted in time and scaled in amplitude. When the inhibiting signal falls, the exciting one is still in rise, i.e. the number of currently spiking and therefore inhibiting neurons decreases, while in the delay, the number of exciting neurons is still increasing. Hence the capacity of hill neuron 400 still rises as the delayed excitation overwhelms the inhibition and finally causes hill neuron 400 to spike.

Inhibiting and exciting input to a neuron is demonstrated in graph 418 of FIG. 4B, in which input 420 is received as inhibiting and input 424 is received as exciting, wherein input 424 has the same shape as input 420, but is scaled down and is delayed in time.

Graph 426 demonstrates the capacity of hill neuron 400 over time. Spike 428 occurring at the hill neuron 400 corresponds to the peak states of the combination of inputs 420 and 424.

The spikes fired by hill neuron 400 may be transmitted over exciting synapse 412 immediately and over inhibiting synapse 408 with a delay to climb neuron 404. Thus, while hill neuron 400 spikes repeatedly during the down slope phase, climb neuron 404 only spikes the first time, and afterwards is suppressed by the delayed inhibiting synapse 408. This may provide the required behavior that is provided to LOI elements 322 of LOI layer 320, in which a single spike is fired upon decrease.

It will be appreciated that the need of climb 404 neuron can be approximated by an inhibitory penalty. Whenever hill neuron 400 spikes, an inhibitory signal may be induced to the hill neuron by an inhibitory self-loop. This results in an inhibitory peak 422, which leads to a steady decaying capacity 430. Until the system relaxes from this penalty, no further spike will occur.

Referring now to FIG. 4C, illustrating a schematic diagram of a memory-like unit, denoted as pre-post unit in FIG. 3A, implemented using elements of spiking neural network, in accordance with certain embodiments of the presently disclosed subject matter.

The unit comprises a pre neuron 440 and a post neuron 444, connected by an STDP synapse 456 having dynamic weight, and a static “bias” synapse 460.

Dynamic synapses are useful as they can change their weight, similarly to a conventional memory unit. However, receiving a value is challenging because it is required not to change the previous value as stored. Therefore, in order to store a value in a dynamic synapse, a deterministic training approach is applied in order to ensure that the value changes only as required.

Once receiving an exciting signal at time t₀, pre neuron 440 which has a self-loop 448 fires spikes constantly, and thus functions like a clock. The spikes are transmitted to post neuron 444 over STDP 456 and bias 460, in accordance with their weights. It will be appreciated that the larger the weight of STDP 456, the earlier post neuron 444 will fire a spike. The spike fired by post neuron 444 arrives to inhibiting neuron 452, which fires and thus inhibits pre neuron 440 and stops it, which makes post neuron 444 fire just once. Due to the delay of the inhibiting spike, pre neuron 440 will fire one or more last spikes after post neuron 444 spiked. This ensures that the synaptic weight will not change too much when a value is received. The unit may further be trained by inducing a second signal t_{ref}, representing the time towards which the unit is trained. Thus, another spike of pre and post is added around t_{ref}, modifying the weight of the STDP synapse 456, such that the overall behavior is as expected.

The general STDP process may be implemented as follows: when pre neuron 440 fires and then post neuron 444 fires, the remaining potential of pre neuron 440 spike increases the weight of STDP 456 which makes post neuron 444 fire earlier in the next iteration, and vice versa. Thus, the weight of STDP 456 is reflected in the firing time of post neuron 444 which is returned to the corresponding changes element 326 of changes layer 324.

Simultaneously to the STDP synapse 456, pre neuron 440 induces spikes through a static bias synapse 460 into post neuron 444. This has multiple effects: 1. A neuron's capacity is decaying exponentially. The static injection partially removes this decay on post neuron 444. Especially for small synapse weights of STDP 456, this decay could prevent post from spiking at all. With static bias synapse 460, a spike of post may be guaranteed. 2. It further scales and shifts the weight intervals, which represent particular state's spike, as shown in FIG. 4D below. 3. Spikes arriving together rise a clearer gap on determining whether post neuron 444 spikes or not. In particular, for small trained STDP weights, this bias synapse adopts that decision, of whether to fire or not. Potential spike positions of post neuron 444 are therefore located closer to spike positions of pre neuron 440.

Thus, the pre-post unit stores and receives a grayscale value (when only time t₀ is given), and learns towards t_{ref} value, if t_{ref} is provided.

Referring now to FIG. 4D showing exemplary experimental plots of the weight of STDP synapse 456 for 8 different training scenarios, wherein in each scenario training is toward a different t_{ref} value. For example, the top graph shows training towards t_{ref}=13 ms between t₀ and the spike time of the post neuron. Each plot shows the weight change over time, wherein the numbers to the right mark the averaged spike time of the post neuron within the retrieve phase. All graphs show training of 59 iterations of 100 ms each. Thus, on the first 5900 ms of each iteration, t₀ and t_{ref} are applied. After the training phase, indicated by the dashed vertical line, only t₀ is applied, and t_{ref} is dropped, representing the retrieve phase of the network. Naturally the oscillation grows in an unsupervised system, but remains within its boundaries.

The t_{ref} signals of FIG. 4D may be used when training the pre-post mechanism. The synaptic weight is indicative of the difference between the pre and post neurons, and is expressed by the spike time (i.e. the delay) of post relatively to inserting t₀ into pre. Thus, the pre-post unit actually stores the grayscale value as received from the respective LOI element 322.

It is noted that the teachings of the presently disclosed subject matter are not bound by the system, neural network and components described with reference to FIGS. 2, 3A, 4A and 4C. Equivalent and/or modified functionality can be consolidated or divided in another manner and can be implemented in any appropriate combination of software with firmware and/or hardware and executed on a suitable device. The neural network can be a standalone entity, or integrated, fully or partly, with other entities which may be collocated or remote from each other.

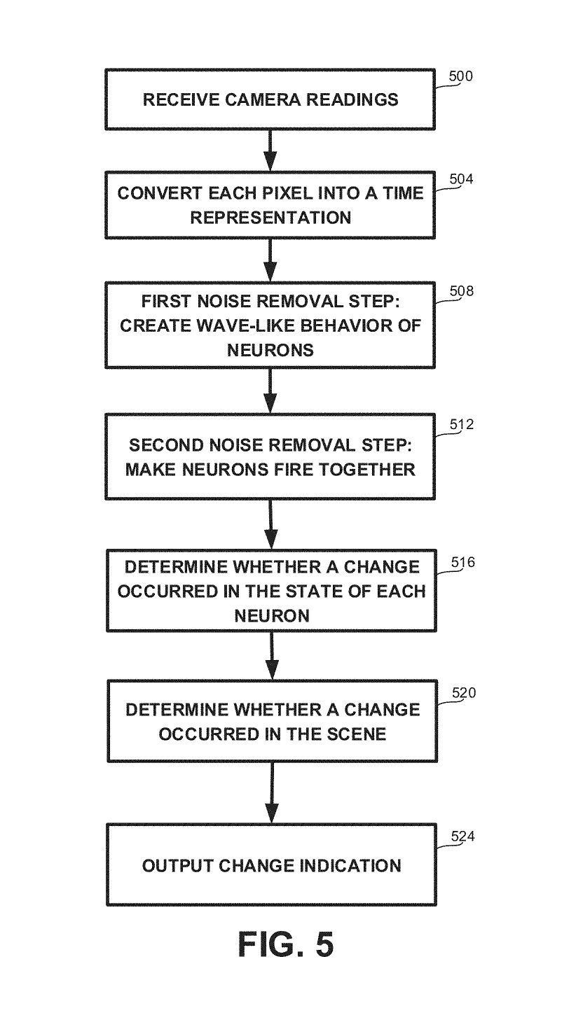

Referring now to FIG. 5, illustrating a generalized flowchart of a method for detecting changes in a monitored scene using a spiking neural network, in accordance with certain embodiments of the presently disclosed subject matter.

On step 500, one or more camera readings can be received from a sensor into a spiking neural network, such as the network depicted in FIG. 3A above. The readings may be received in a matrix form, wherein each pixel represents a gray level at the respective area of the captured scene.

On step 504, each pixel can be converted into a time representation. For example, a spike may be fired at a point in time representing the received gray level. The spikes can be fired from a layer of neurons, in which the active synapses arrange the neurons in a matrix-like layer. Each neuron is associated with one pixel, therefore a spike may (or may not, depending on the input) be fired per each pixel received on step 500.

On step 508, a first noise removal step may take place, comprising creating a wave-like behavior of the received spikes, for example by making neurons connected by a synapse spike each other. The wave-like behavior eliminates small noises, for example a single lightened pixel, and spreads actual “happening” in the captured scene over more neurons.

On step 512 a second noise removal step may take place, comprising concentrating spikes fired by neurons over a span of time into one spike fired after the number of spikes has reached a maximal value, thus assigning a close-by spike firing times to neurons associated with different times, and simulating more uniform gray level in the “happening” area. The second noise removal step may be performed by the hillclimb mechanism described in association with FIG. 5A above.

It will be appreciated that different or additional noise removal steps may take place, and the disclosure is not limited to the two noise removal steps disclosed. In further embodiments, only one of the disclosed noise removal steps may be performed.

On step 516, per each neuron it may be determined whether there is a change between a previous state and a current state of the neuron, using a memory-like unit, for example by using the pre-post mechanism described in association with FIG. 4C above.

On step 520, it is determined whether a change occurred in the scene, for example in accordance with the number, percentage or distribution of the neurons in which a state change was detected on step 516.

On step 524, an indication to a change in the scene may be output, for example sent to a control center, fire an alarm, send a message, or the like.

It is noted that the teachings of the presently disclosed subject matter are not bound by the flow chart illustrated in FIG. 5, the illustrated operations can occur out of the illustrated order. It is also noted that whilst the flow chart is described with reference to the neural network of FIG. 3A, this is by no means binding, and the operations can be performed by elements other than those described herein.

It is noted that in some embodiments of the disclosure, the disclosed network sues unidirectional and feed forward approach, i.e., spikes travel between the layers in one direction only and do not return to a preceding layer.

Although FIG. 3A and the associated disclosure shows synapses connecting corresponding neurons in neighboring layers, it will be appreciated that this 1-1 relationship (excluding the hillclimb and pre-post neurons) is not mandatory, and one or more elements of a layer, for example TTFS element 314 or waver element 318, can excite one or more neurons in another layer, for example waver layer 316 or LOI 320, respectively, other than the corresponding neurons.

It is also noted that in some embodiments of the disclosure, the disclosed network is trained for single spikes and does not store a pattern or adapt it over time.

It is also noted that some embodiments of the disclosure relate to unsupervised training, which thus saves labor and time in deploying a system.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

What is claimed is:

1. A computer-implemented method for identifying anomalies in a monitored scene, comprising:
receiving into a spiking neural network sensor readings from a capture device monitoring a scene; and
outputting an indication to a change in the scene,
wherein the spiking neural network comprises a multiplicity of layers, each of the multiplicity of layers comprising a neuron per substantially each pixel in a sensor capturing the monitored scene, and
wherein at least one of the layers comprises a memory-like unit for comparing states occurring at a time difference.

2. The method of claim 1, wherein the memory-like unit uses a spike-timing-dependent plasticity (STDP) process.

3. The method of claim 1, wherein the neural network is implemented in hardware.

4. The method of claim 1, wherein the spiking neural network comprises:
a time to first spike layer comprising a grid of first neurons, each of the first neurons receiving a sensor reading and converting the sensor reading into time by firing a first spike;
a waver layer comprising a grid of second neurons, each of the second neurons connected to receive as input the first spike issued by a corresponding first neuron, the waver layer configured to perform first noise filtering within the input and fire a second set of spikes;
a layer of interest comprising a grid of third neurons, each of the third neurons connected to receive as input spikes from the second set of spikes issued by a corresponding second neuron, the layer of interest configured to perform a second noise filtering stage by at least part of the third neurons firing a third set of spikes substantially simultaneously; and
a change layer comprising a grid of fourth neurons, each of the fourth neurons connected to receive as input a spike from the third set of spikes issued by a corresponding third neuron, and detecting a change between a stored state and a current state using the memory-like unit.

5. The method of claim 4, wherein the second neurons of the waver layer are interconnected, and wherein the first noise filtering is performed by at least one of the second neurons firing a spike to another neuron from the second neurons, thereby at least one of the second neurons firing multiple spikes per iteration.

6. The method of claim 4, further comprising a hillclimb neuron for receiving input from a multiplicity of the second neurons and providing output to the third neurons, the hillclimb neuron spiking when a number of input spikes decreases, and making the at least part of the third neurons fire the third set of spikes fire substantially simultaneously.

7. The method of claim 4, wherein an anomaly is detected as change detected in at least a predetermined number of the fourth neurons.

8. The method of claim 1, wherein the method is unsupervised.

9. A computerized system for projecting a machine learning model, the system comprising a processor, the system configured to:
receiving sensor readings from a capture device monitoring a scene into a spiking neural network; and
outputting by the processor an indication to a change in the scene,
wherein the spiking neural network comprises a multiplicity of layers, each of the multiplicity of layers comprising a neuron per substantially each pixel in a sensor capturing the monitored scene, and
wherein at least one of the layers comprises a memory-like unit for comparing states occurring at a time difference.

10. The system of claim 9, wherein the memory-like unit uses a spike-timing-dependent plasticity (STDP) process.

11. The system of claim 9, wherein the neural network is implemented in hardware.

12. The system of claim 9, wherein the spiking neural network comprises:
a time to first spike layer comprising a grid of first neurons, each of the first neurons receiving a sensor reading and converting the sensor reading into time by firing a first spike;
a waver layer comprising a grid of second neurons, each of the second neurons connected to receive as input the first spike issued by a corresponding first neuron, the waver layer configured to perform first noise filtering within the input and fire a second set of spikes;
a layer of interest comprising a grid of third neurons, each of the third neurons connected to receive as input spikes from the second set of spikes issued by a corresponding second neuron, the layer of interest configured to perform a second noise filtering stage by at least part of the third neurons firing a third set of spikes fired substantially simultaneously; and
a change layer comprising a grid of fourth neurons, each of the fourth neurons connected to receive as input a spike from the third set of spikes issued by a corresponding third neuron, and detecting a change between a stored state and a current state using the memory-like unit.

13. The system of claim 12, wherein the second neurons of the waver layer are interconnected, and wherein the first noise filtering is performed by at least one of the second neurons firing a spike to another neuron from the second neurons, thereby at least one of the second neurons firing multiple spikes per iteration.

14. The system of claim 12, further comprising a hillclimb neuron for receiving input from a multiplicity of the second neurons and providing output to the third neurons, the hillclimb neuron spiking when a number of input spikes decreases, and making the at least part of the third neurons fire the third set of spikes fire substantially simultaneously.

15. The system of claim 12, wherein an anomaly is detected as change detected in at least a predetermined number of the fourth neurons.

16. A computer program product comprising a computer readable storage medium retaining program instructions, which program instructions when read by a processor, cause the processor to perform a method comprising:
receiving into a spiking neural network sensor readings from a capture device monitoring a scene; and
outputting an indication to a change in the scene,
wherein the spiking neural network comprises a multiplicity of layers, each of the multiplicity of layers comprising a neuron per substantially each pixel in a sensor capturing the monitored scene, and
wherein at least one of the layers comprises a memory-like unit for comparing states occurring at a time difference.
